(19) United States
(12) Patent Application Publication
(10) Pub. No.: US 2007/0153082 A1
(43) Pub. Date: Jul. 5, 2007

(54) Portable electronic device and method for sharing a common storage device via a by-pass mode

(76) Inventors: Chih-Shen Lin, Hsinchu (TW); Te-Yu Kao, Hsinchu (TW); Young-Fei Chien, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/367,475

(22) Filed: Mar. 6, 2006

(30) Foreign Application Priority Data
Dec. 30, 2005 (TW) 94147790

(51) Int. Cl. H04N 7/14

(52) U.S. Cl. 348/14.01

(57) ABSTRACT

A portable electronic device for sharing a common storage device via a by-pass mode is disclosed. The portable electronic device includes a portable electronic system, a DSC (Digital Still Camera), and a mass storage system. The portable electronic system has a first process unit and a signal multiplexer electrically connected with each other. The DSC system has a second process unit. The DSC system is electrically connected with the signal multiplexer. The mass storage system is electrically connected with the signal multiplexer. Whereby, when a raw image signal is captured via the DSC system, the raw image signal is processed via the second process unit to obtain a predetermined image signal. The predetermined image signal is then stored in the mass storage system via the signal multiplexer.

### BACKGROUND OF THE INVENTION

1. Field of The Invention

The present invention relates to a portable electronic device and a method for sharing a common storage device via a by-pass mode, and particularly relates to a portable electronic system (such as mobile phone system, a PDA system or a PDA phone system) and a DSC (Digital Still Camera) system to share a common storage device via a switching means of a signal multiplexer.

2. Description of the Related Art

With the coming of the age of information technology, combined with the improvement of the Internet and other communication techniques, cell phones (or mobile phones) have become one of the most widespread communication tools. Cell phone products are loved and utilized by many consumers for their small size, light weight, portability, numerous functions, and low price. People can send messages to their friends, family, or business associates immediately via their cell phone. As such, cell phones are more convenient and faster than traditional landline telephones. Cell phone users regularly receive and send information via wireless communication and can use text messages and emails to achieve this function.

Referring to FIG. 1, mobile phones commonly include a mobile phone system 1a, a DSC (Digital Still Camera) system 2a and a storage device 3a. The mobile phone system 1a has a processor 10a. Moreover, the DSC system 2a is used to capture raw image signals and transmit the raw image signals to the processor 10a to perform related image processes. The processed image signals are then stored in the storage device 3a.

However, the raw image signals that are captured via the DSC system 2a must be processed via the processor 10a of the mobile phone system 1a for obtaining predetermined images. Hence, the quality of the image process is limited by the image process capability of the processor 10a. That is to say, because the quality and functions of the DSC system 2a that are currently applied to mobile phones 1a are not usually as up to date as the digital cameras disposed in the mobile phones, the quality and the function of the DSC system 2a has not improved as much as is in fact possible.

### SUMMARY OF THE INVENTION

The present invention provides a portable electronic device and a method for sharing a common storage device via a by-pass mode. The portable electronic device has a portable electronic system (such as a mobile phone system, a PDA system or a PDA phone system) and a DSC (Digital Still Camera) system. The portable electronic system and the DSC system can share a common storage device via a switching means of a signal multiplexer.

A first aspect of the present invention is a portable electronic device for sharing a common storage device via a by-pass mode. The portable electronic device comprises a portable electronic system, a DSC (Digital Still Camera) and a mass storage system. The portable electronic system has a first process unit and a signal multiplexer electrically connected with each other. The DSC system has a second process unit, and the DSC system is electrically connected with the signal multiplexer. The mass storage system is electrically connected with the signal multiplexer. Whereby, when a raw image signal is captured via the DSC system, the raw image signal is processed via the second process unit to obtain a predetermined image signal, and the predetermined image signal is stored in the mass storage system via the signal multiplexer.

A second aspect of the present invention is a method for sharing a common storage device via a by-pass mode. The method comprises: turning on a portable electronic system having a first process unit and a DSC (Digital Still Camera) system having a second process unit; capturing at least one raw image signal via the DSC system; processing the raw image signal via the second process unit of the DSC system to obtain a predetermined image signal; and storing the predetermined image signal in a mass storage system via a signal multiplexer of the portable electronic system.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a function block diagram of a mobile phone according to a prior art;

FIG. 2 is a function block diagram of a portable electronic device for sharing a common storage device via a by-pass mode according to the present invention; and

FIG. 3 is a flowchart of a method for sharing a common storage device via a by-pass mode according to the present invention.

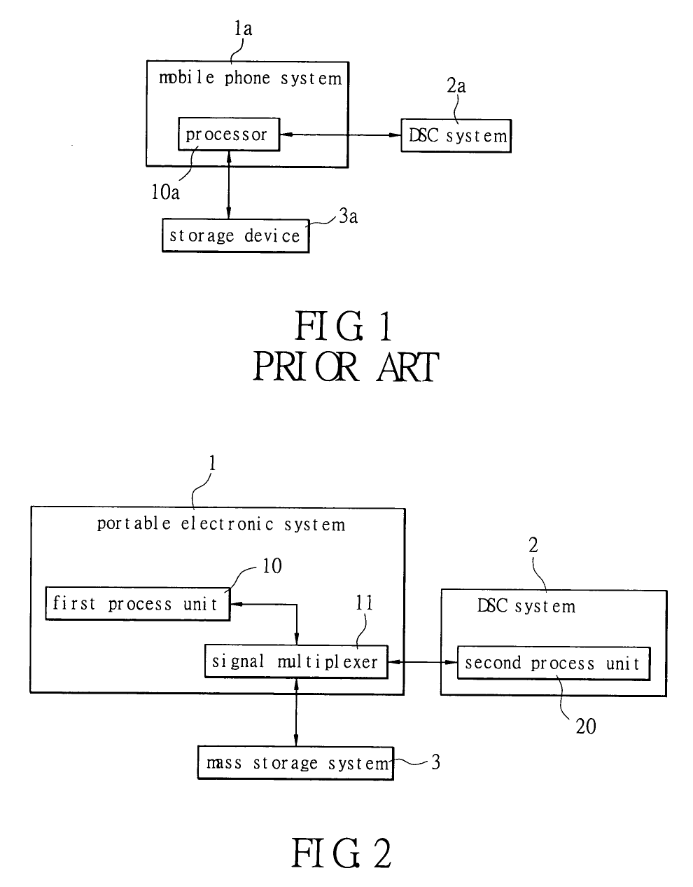

### DETAILED DESCRIPTION OF PREFERRED BEST MOLDS

Referring to FIG. 2, the present invention provides a portable electronic device for sharing a common storage device via a by-pass mode. The portable electronic comprises a portable electronic system 1, a DSC (Digital Still Camera) 2, and a mass storage system 3.

The portable electronic system 1 has a first process unit 10 and a signal multiplexer 11 electrically connected with each other. The DSC system 2 has a second process unit 20, and the DSC system 2 is electrically connected with the signal multiplexer 11. The mass storage system 3 is also electrically connected with the signal multiplexer 11.

Moreover, according to different demands, the portable electronic system 1 can be a mobile phone system, a PDA phone system or a PDA system. In addition, both the first process unit 10 and the second process unit 20 can be a baseband CUP, a media processor or an application processor. Furthermore, the portable electronic system 1 can be electrically connected with the DSC system 2 via an I²C (Inter-Integrated Circuit) bus or any type of transmission line.

When a raw image signal is captured via the DSC system 2, the raw image signal is processed via the second process unit 20 to obtain a predetermined image signal. The predetermined image signal is stored in the mass storage system 3 via the signal multiplexer 11. In other words, the signal multiplexer 11 is controlled via the first process unit 10 to select data that has been processed by the first process unit 10 or the second process unit 20 to be stored in the mass storage system 3.

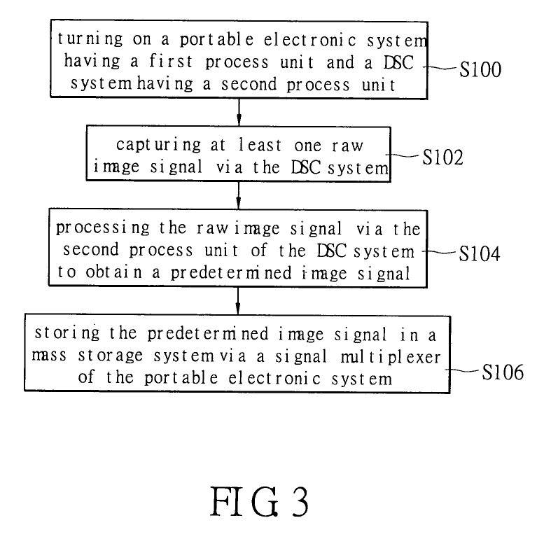

Referring to FIG. 3, the present invention provides a method for sharing a common storage device via a by-pass mode. The method comprises: turning on a portable electronic system 1 having a first process unit 10 and a DSC (Digital Still Camera) system 2 having a second process unit 20 (S100); capturing at least one raw image signal via the DSC system 2 (S102); processing the raw image signal via the second process unit 20 of the DSC system 2 to obtain a predetermined image signal (S104); finally, storing the predetermined image signal in a mass storage system 3 via a signal multiplexer 11 of the portable electronic system 1 (S106).

In conclusion, the portable electronic system 1 and the DSC system 2 can share a common storage device via a switching means of a signal multiplexer 11. In other words, the present invention provides a dual system (the portable electronic system 1 and the DSC system 2), and the dual system has its own processor (the portable electronic system 1 has a first process unit 10 and the DSC system has a second process unit 20) to perform related image processing for obtaining processed image data. Hence, a user can selectively store the processed image data from the portable electronic system 1 or the DSC system 2 in the mass storage system 3 via the signal multiplexer 11 for achieving the goal of two systems sharing the mass storage system 3.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A portable electronic device for sharing a common storage device via a by-pass mode, comprising:
a portable electronic system having a first process unit and a signal multiplexer electrically connected with each other;
a DSC (Digital Still Camera) system having a second process unit, wherein the DSC system is electrically connected with the signal multiplexer; and
a mass storage system electrically connected with the signal multiplexer;
whereby, when a raw image signal is captured via the DSC system, the raw image signal is processed via the second process unit to obtain a predetermined image signal, and the predetermined image signal is stored in the mass storage system via the signal multiplexer.

2. The portable electronic device as claimed in claim 1, wherein the portable electronic system is a mobile phone system.

3. The portable electronic device as claimed in claim 1, wherein the portable electronic system is a PDA phone system.

4. The portable electronic device as claimed in claim 1, wherein the portable electronic system is a PDA system.

5. The portable electronic device as claimed in claim 1, wherein the first process unit is a baseband CUP, a media processor or an application processor, and the second process unit is a baseband CUP, a media processor, or an application processor.

6. The portable electronic device as claimed in claim 1, wherein the portable electronic system is electrically connected with the DSC system via an I²C (Inter-Integrated Circuit) bus.

7. The portable electronic device as claimed in claim 1, wherein the signal multiplexer is controlled via the first process unit to select data that have been processed by the first process unit or the second process unit to be stored in the mass storage system.

8. A method for sharing a common storage device via a by-pass mode, comprising:
turning on a portable electronic system having a first process unit and a DSC (Digital Still Camera) system having a second process unit;
capturing at least one raw image signal via the DSC system;
processing the raw image signal via the second process unit of the DSC system to obtain a predetermined image signal; and
storing the predetermined image signal in a mass storage system via a signal multiplexer of the portable electronic system.

9. The method as claimed in claim 8, wherein the portable electronic system is a mobile phone system.

10. The method as claimed in claim 8, wherein the portable electronic system is a PDA phone system.

11. The method as claimed in claim 8, wherein the portable electronic system is a PDA system.

12. The method as claimed in claim 8, wherein the first process unit is a baseband CUP, a media processor, or an application processor, and the second process unit is a baseband CUP, a media processor, or an application processor.

13. The method as claimed in claim 8, wherein the portable electronic system is electrically connected with the DSC system via an I²C (Inter-Integrated Circuit) bus.

14. The method as claimed in claim 8, wherein the signal multiplexer is controlled via the first process unit to select data that has been processed by the first process unit or the second process unit to be stored in the mass storage system.
